(19) United States
(12) Patent Application Publication
(10) Pub. No.: US 2011/0002425 A1
(43) Pub. Date: Jan. 6, 2011

(54) CARRIER FREQUENCY OFFSET SYNCHRONIZER FOR OFDM RECEIVER AND METHOD

(75) Inventor: Ming Gong, Shanghai (CN)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/918,873

(22) PCT Filed: Feb. 25, 2009
(86) PCT No.: PCT/IB09/50763

§ 371 Date: Aug. 23, 2010

Related U.S. Application Data
(60) Provisional application No. 61/067,204, filed on Feb. 25, 2008.

(51) Int. Cl. H04J 11/00

(52) U.S. Cl. 375/344

(57) ABSTRACT

A method of synchronizing a receiver to a received orthogonal frequency division multiplexing (OFDM) signal. The receiver includes a carrier frequency offset synchronizer having a carrier frequency offset detector, a frequency-locked loop having a controller. A transmitted signal having a carrier frequency is received by the receiver. A carrier frequency offset is estimated by comparing the carrier frequency of the transmitted signal and a reference frequency of a locally generated signal of the receiver. A plurality of parameters of the frequency-locked loop is determined to adjust the reference frequency to reduce the carrier frequency offset. Accordingly, the frequency-locked loop achieves frequency tracking of the OFDM signal.

Orthogonal frequency-division multiplexing (OFDM) is a digital multi-carrier modulation scheme that uses a large number of closely-spaced orthogonal sub-carriers to carry data. OFDM is widely used in modern wideband wireless systems, such as Worldwide Interoperability for Microwave Access (WiMax) and Digital Video Broadcasting—Terrestrial/Handheld (DVB-T/H). In China, Satellite and Terrestrial Interactive Multiservice Infrastructure (STiMi), which is released as an industrial physical standard for the mobile multimedia broadcasting, also employs OFDM as the basic modulation scheme. OFDM technology has the ability to handle wideband fading easily and offers high spectrum efficiency. However, OFDM is susceptible to frequency synchronization errors, such as carrier frequency offset and symbol timing error. In order to communicate with an OFDM transmitter (hereinafter as “transmitter”), an OFDM receiver (hereinafter as “receiver”) needs to manage to synchronize with the transmitter accurately in terms of carrier frequency, sampling frequency and symbol timing.

The carrier frequency offset (CFO) between the transmitter and the receiver can be caused by the inaccuracy and the variance of the frequencies of the oscillator crystals of the transmitter and receiver. The receiver should be able to estimate the CFO and then compensate for it. Therefore, it is desirable to provide an apparatus that can quickly compensate the CFO experienced at the receiver. It is also desirable to provide a method that can quickly compensate the CFO at the receiver.

Embodiments of the present invention provide a carrier frequency synchronizer for OFDM receiver and a method of synchronizing a receiver to a received OFDM signal. In one exemplary embodiment according to the present invention, a method of synchronizing a receiver to a received orthogonal frequency division multiplexing (OFDM) signal is provided. The receiver includes a carrier frequency offset synchronizer having a carrier frequency offset detector and a frequency-locked loop. A transmitted signal having a carrier frequency is received by the receiver. A carrier frequency offset is estimated by comparing the carrier frequency of the transmitted signal and a reference frequency of a locally generated signal of the receiver. A plurality of parameters of the frequency-locked loop are determined to adjust the reference frequency to reduce the carrier frequency offset. The plurality of parameters are adaptive to the estimated carrier frequency offset. Then, the reference frequency is adjusted corresponding to the plurality of parameters of the frequency-locked loop. The procedures set forth above are repeated for a successive number of OFDM sample times.

In another exemplary embodiment according to the present invention, an apparatus for synchronizing a receiver to a received orthogonal frequency division multiplexing (OFDM) signal is provided. The apparatus includes a carrier frequency offset detector, a loop filter, a compensating unit, and a controller. The carrier frequency offset detector is configured to receive an OFDM signal and output an offset signal. The loop filter is coupled to the carrier frequency offset detector to receive the offset signal and output a filtered signal. The compensating unit is coupled to the loop filter to receive the filtered signal and output a compensation signal. And the controller is coupled to the carrier frequency offset detector and the compensating unit to receive the offset signal and the compensation signal, respectively, to control a plurality of performance parameters of the loop filter. Furthermore, the carrier frequency offset detector compares the received OFDM signal with a local reference signal adjusted by the compensation signal to produce the offset signal.

The compensating unit may include a numeric oscillator. The controller may be coupled to the loop filter to control the loop filter in accordance with the plurality of performance parameters of the loop filter. The controller may further output a control signal to modify the filtered signal and provide the modified filtered signal to the compensation unit.

The accompanying drawings, together with the specification, illustrate exemplary embodiments of the present invention, and, together with the description, serve to explain the principles of the present invention.

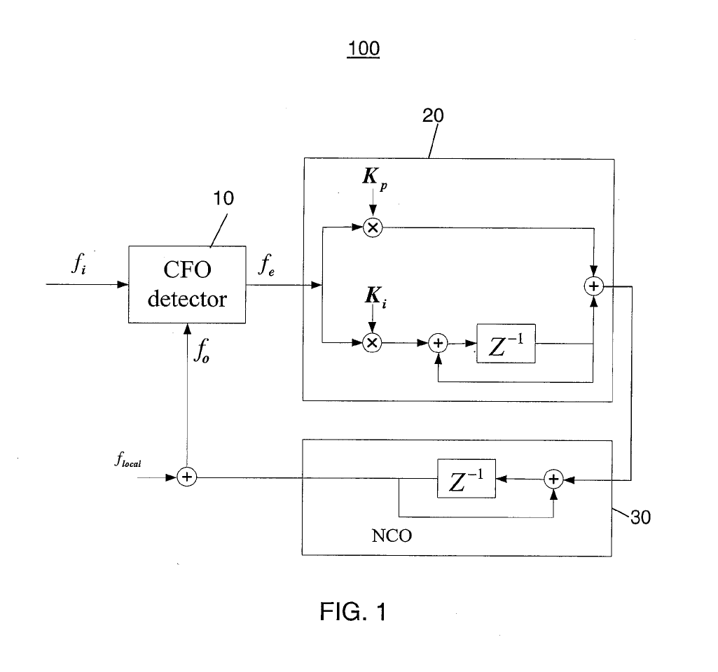

FIG. 1 is a block diagram illustrating a CFO synchronizer in the form of a conventional frequency-locked loop.

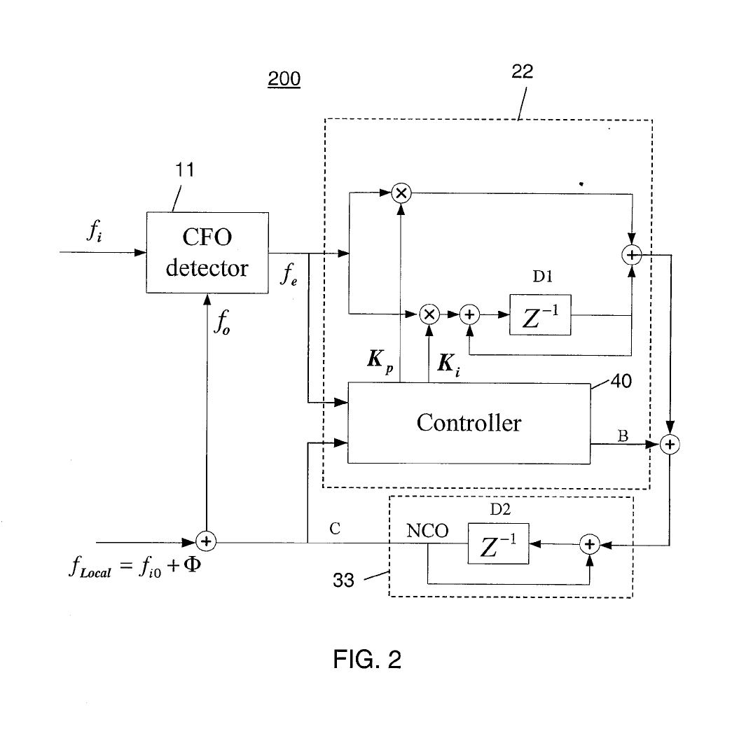

FIG. 2 is a block diagram illustrating a CFO synchronizer according to an embodiment of the present invention

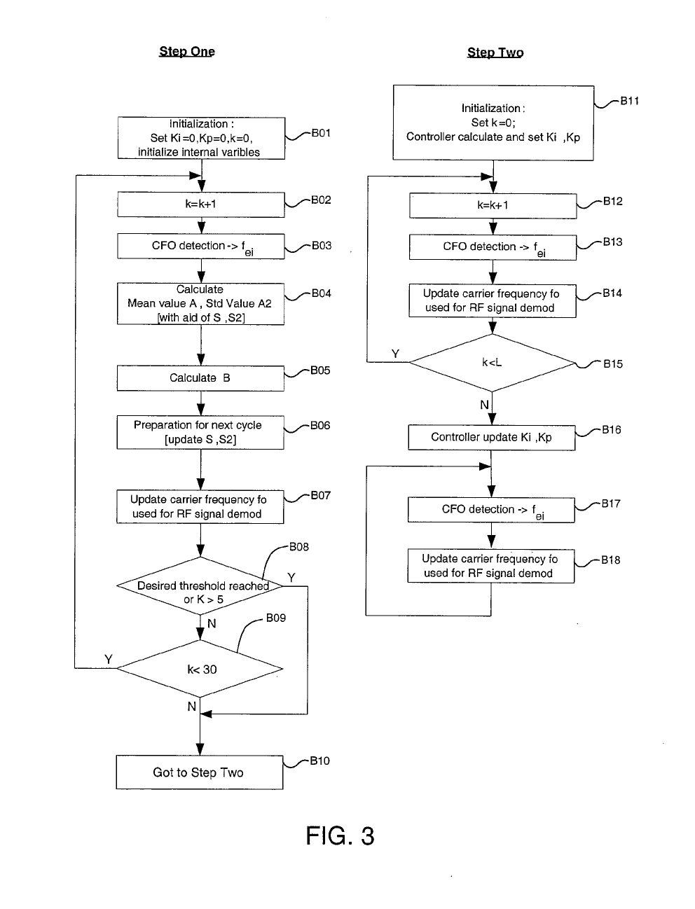

FIG. 3 is a flowchart illustrating the operations of a CFO synchronizer according to an embodiment of the present invention.

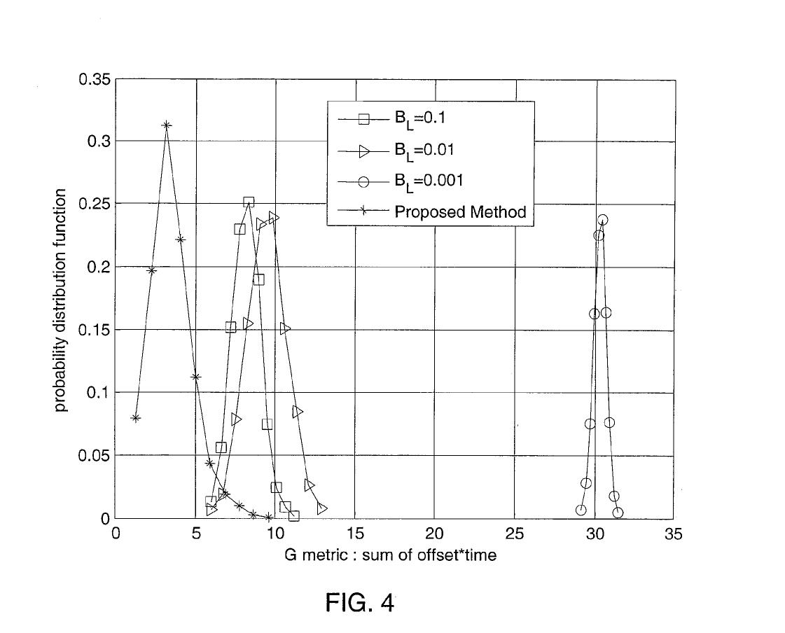

FIG. 4 is a chart illustrating the simulation results of a typical CFO synchronizer and a CFO synchronizer according to an embodiment of the present invention.

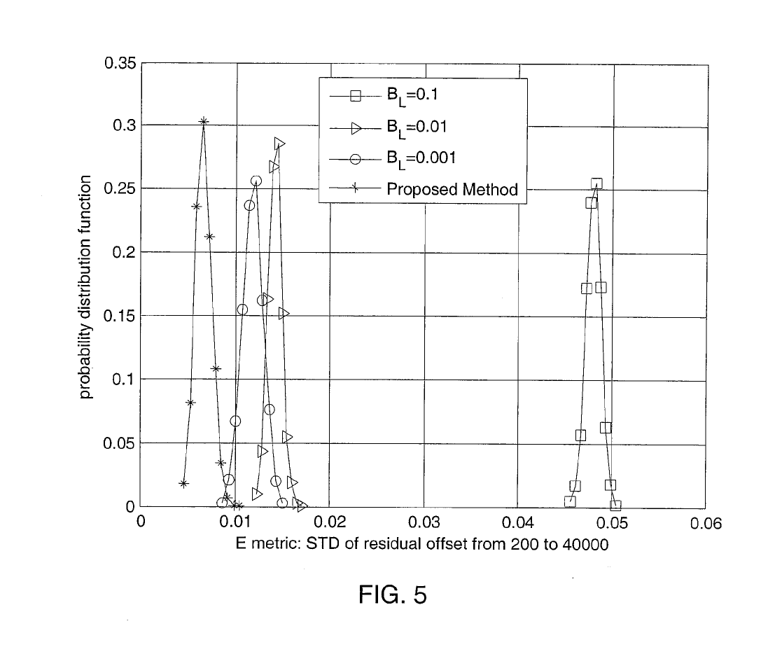

FIG. 5 is a chart illustrating the simulation results of a typical CFO synchronizer and a CFO synchronizer according to an embodiment of the present invention.

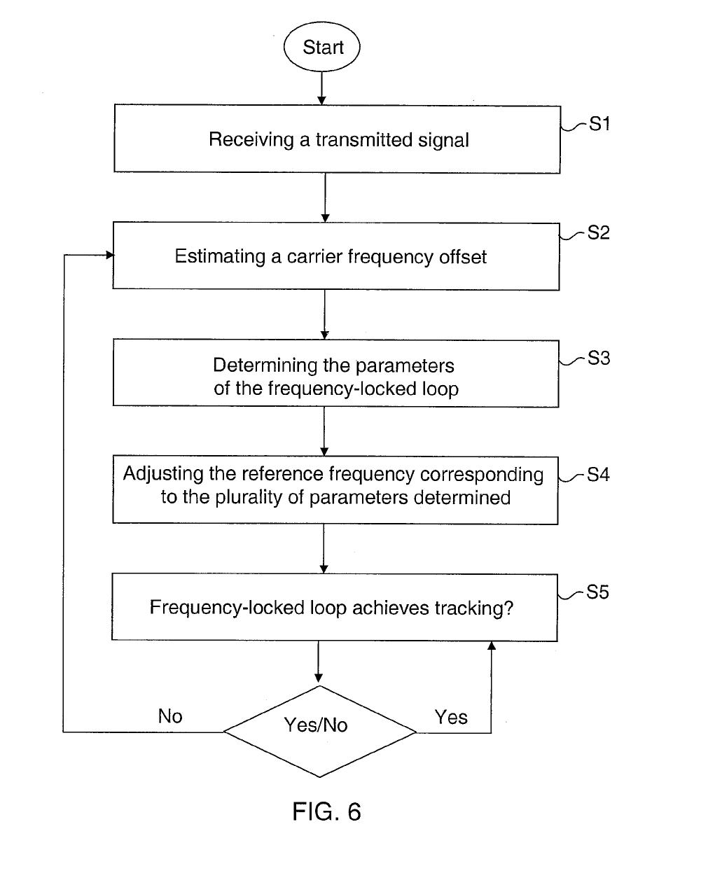

FIG. 6 illustrates a flowchart of a method of synchronizing a receiver to the frequency of a transmitter according to an embodiment of the present invention.

Detailed descriptions will be made below in reference to certain exemplary embodiments according to the present invention. The drawings and descriptions are to be regarded as illustrative in nature and not restrictive.

In order to estimate CFO, a typical CFO estimating method exploits the structure of the cyclic preamble of an OFDM symbol, which is located at the front portion of an OFDM symbol for the purpose of reducing inter-symbol interference (ISI). The signal Sₙ(t) transmitted in the n^{th} OFDM sub-carrier can be represented as:

$${s}_{n} ( t ) = \frac{1}{N} {\sum }_{k = 0}^{N - 1} {a}_{k} {e}^{- j2π k Δ {f}_{s} ( t - {N}_{cp} {T}_{s} - {nN}_{s} {T}_{s} )} , \\ {nN}_{s} {T}_{s} \leq t \leq ( n + 1 ) {N}_{s} {T}_{s} \qquad ( 1 )$$

where Tₛ, is the basic sample interval, and Δfₛ is the bandwidth of the OFDM sub-carrier. N is number of OFDM sub-carriers, and N_{CP} is the length of the cyclic preamble. αₖ is the symbol carried on the k^{th} OFDM sub-carrier. The part of the signal in nNₛTₛ≦t≦nNₛTₛ+N_{cp}T ₛ is the so called cyclic preamble.

In the receiver, samples for the n^{th} OFDM symbol in the baseband are taken as:

rₙ(i)=e^{j2πΔf}^{_{c}}^{t}|[sₙ(t)*h(t)]+w(t)|_{t=nN}_{ₛ}_{T}_{ₛ}_{+i T}_{ₛ}i=0,1, . . . ,Nₛ−1 (2)

where h(t) is the channel impulse response function and Δf_{c} is the CFO between the transmitter and the receiver.

The CFO can be estimated as:

$${( Δ {f}_{c} )}_{n} = \frac{1}{2 π} angle \{ {\sum }_{i = {N}_{CP} - {L}_{1}}^{{N}_{CP} - {L}_{2} - 1} r ( i ) * r ( i + N ) \} \qquad ( 3 )$$

where [N_{CP}-L₁, N_{CP}-L₂-1] is the range for the accumulation. (Δf_{c})ₙ is the normalized CFO and in the following description, all the CFOs referred to are normalized by the bandwidth of a sub-carrier unless stated otherwise.

After the CFO is detected by a CFO detector, the CFO can be compensated with the aid of a numeric oscillator (NCO) sample by sample, e.g., by implementing coordinate rotation digital computer (CORDIC) algorithm in hardware. The output of such NCO can be represented as:

u(i)=r(i)e^{-2jπi(Δf}^{_{c}}⁾^{ₙ}^{T}^{ₛ} (4)

In practical application, the estimated CFO from the CFO detector may not be very accurate due to noise, interference and varying fading channel. It is possible that more CFO is created if improper CFO compensation is performed. Generally, a closed loop feedback structure such as a frequency-locked loop is introduced to deal with the frequency deviation. The frequency-locked loop can help the receiver to lock its local frequency to the one of the transmitter.

FIG. 1 is a block diagram of a conventional CFO synchronizer 100 in the form of a frequency-locked loop. The frequency-locked loop includes a CFO detector 10, a loop filter 20, and a numeric oscillator (NCO) 30 (e.g., coordinate rotation digital computer (CORDIC) oscillator). The frequency-locked loop can decrease the CFO gradually. The capability of the noise/interference restriction of the frequency-locked loop is defined as noise bandwidth B_{L}. The relationship between noise bandwidth and frequency variance of the frequency-locked loop can be expressed as:

$$\frac{{σ}_{o}^{2}}{{σ}_{i}^{2}} = \frac{2 {B}_{L}}{{B}_{i}} \qquad ( 5 )$$

Where σₒ is the variance of the output frequency from the NCO 10 and σᵢ is the variance of the output frequency of the CFO detector, which is the metric of the measurement of noise or error. Bᵢ is the bandwidth of the noise, and it can be regarded as unit one in this disclosure for the convenience of explaining the embodiments of the present invention. In order to decrease the noise level in the output frequency of the NCO, according to formula (5), small B_{L}, is generally preferred, as shown in Table I.

TABLE I
B_{L} and the corresponding σₒ/σᵢ

| | B_{L} | | | | | | |
|---|---|---|---|---|---|---|---|
| | 0.001 | 0.002 | 0.005 | 0.01 | 0.02 | 0.05 | 0.1 |
| σₒ/σᵢ | 0.0447 | 0.0632 | 0.1000 | 0.1414 | 0.2000 | 0.3162 | 0.4472 |

However, the time for reducing the CFO is rather long with a small B_{L}, as shown in Table II.

TABLE II
B_{L} and the time for the instant transition procedure

| | B_{L} | | | | | | |
|---|---|---|---|---|---|---|---|
| | 0.001 | 0.002 | 0.005 | 0.01 | 0.02 | 0.05 | 0.1 |
| n_{T} | 3000 | 1500 | 600 | 300 | 150 | 60 | 30 |

where n_{T} is the time, in unit of loop working cycle, when the residual error reaches below 2% given an unit step stimulus at time 0.

As to the CFO detector 10, the standard deviation of the CFO is as large as 0.2 in some cases, such as in cases with very high mobility and/or in cases with very low carrier noise power ratio (CNR). According to known theories in the art as well as the simulation results, when the residual of CFO is less than 1%, the effect of CFO can almost be neglected for the receiver when quadrature phase-shift keying (QPSK) is employed in the OFDM system. Thus, the value of B_{L} has to be as small as 0.001. For the second order frequency-locked loop shown in FIG. 1, it can be determined that the time for the frequency-locked loop to converge is as much as 3000*0.2=600 units of loop working cycle. That is, the receiver is under the influence of large CFO for a long period of time when the OFDM system has a large initial CFO.

Since receiver designer generally does not have the knowledge on the level of the measurement deviation, the receiver is typically designed in the most conservative way to deal with the worst case scenario. Thus, a very small B_{L} will be chosen for the lock loop. As a result, the receiver suffers from a long synchronization time causing undesirable delay to a user of the OFDM system. In particular, as to STiMi receiver, in some cases, if the receiver misses the signaling time slot when power is on due to slow CFO synchronization, the receiver has to wait for one or more seconds to achieve synchronization. In some other OFDM applications, such as mobile multimedia broadcasting, burst mode is frequently used. In these types of application, if the CFO synchronization is slow, the receiver needs to wake up beforehand with a larger margin in time, which results in more power consumption.

Embodiments of the present invention provide a CFO synchronizer and method with reduced synchronization time to provide fast tracking of the CFO under various less than optimal wireless channels. A CFO synchronizer in accordance with the embodiments includes a modified frequency-locked loop with variable parameters, which are adaptive to the results of the CFO detector in various channel cases. The converging procedure of the frequency-locked loop is based on the calculation of the deviation of the detected CFO.

FIG. 2 illustrates a CFO synchronizer 200 according to an exemplary embodiment of the present invention. The CFO synchronizer 200 includes a CFO detector 11, a loop filter 22, and a numeric oscillator (NCO) 33. The loop filter 22 includes a controller 40 that provides the parameters Kᵢ and Kₚ of the loop filter 22. The controller 40 adaptively changes the values of Kᵢ and Kₚ to converge the frequency of a local reference signal of the receiver to the frequency of a transmitted signal. The controller 40 may be implemented by hardware logic or programmable logic circuits. Furthermore, the controller 40 may be implemented by a programmable computing unit (e.g., microprocessor, DSP, VLSI and FPGA). The loop filter 22 also includes a memory unit D1 (e.g., a register). The numeric oscillator (NCO) 33 includes a memory unit D2 (e.g., a register). f_{Local} is the frequency of a local oscillator. fᵢ is the frequency of the transmitter. fₒ is frequency used by receiver to demodulate the signal received from the transmitter. fᵢ₀ is the frequency of the transmitter at the initial time and Φ is the initial frequency offset. The output of the CFO detector is fe=(fₒ−fᵢ)+ω. ωis the error or deviation of the CFO detector. In a starting phase, the frequencies of both the receiver and the transmitter are assumed to change slowly. Thus, it can be assumed that fe≈Φ+ω. Before the receiver begins to detect the CFO, the initial value of the memory units D1 and D2 (shown in FIG. 2 as unit Z⁻¹) are set as zero. For simplicity, zero frequency can be assumed here in the baseband analysis.

During the operation of the frequency-locked loop shown in FIG. 2, the value of fₒ are determined by the following equations:

fₒ[i]=f_{local}+D2[i]

D2[i+]=D2[i]+Kₚ×fe[i]+D1[i]+B

D1[i+1]=D1[i]+Kᵢ×fe[i]

wherein i is incremented during each cycle of the frequency-locked loop.

FIG. 3 is a flowchart illustrating the operations of an exemplary embodiment according to the present invention.

Here, a brief description of each block of the flowchart in FIG. 3 is provided. In block B00, the CFO synchronizer 200 is initialized. In block B02, a loop variable k is incremented. In block B03, detected CFO offset is compared to a desired threshold value. In block B04, a mean value A and a standard deviation value A2 are calculated. In block B05, a value of B is calculated. In block B06, the values of S and S2 are updated to prepare for the next cycle of operation. In block B07, the local reference carrier frequency of the receiver is updated. In block B08, a decision is made whether to break the loop including blocks B02-B07. In block B09, a decision is made whether to continue the loop including blocks B02-B08. In block B10, operation enters step two.

In block B11, another initialization is performed and the controller 40 calculates the values of K, and K. In block B12, the variable k is incremented. In block B13, the current CFO offset is compared to the desired threshold value. In block B14, the local reference carrier frequency of the receiver is updated. In block B15, a decision is made whether to continue the loop including blocks B12-B14. In block B16, the controller 40 updates the values of K, and Kₚ. In block B17, the current CFO offset is compared to the desired threshold value. In block B18, the local reference carrier frequency of the receiver is updated.

In the step one, loop parameters Kᵢ and Kₚ are set as zeros. The target residual CFO is set to a desired threshold A (e.g., 0.02).

The CFO synchronizer 200 of FIG. 2 is operated in two steps as illustrated in FIG. 3. In step one, the following procedures are performed.

```
S=0, S2=0,
Loop k=1 to 30,
  M₁ = k*k; (when k=1, M₁=0)
  M₂ =(k+1)*(k+1);
  Loop i =M₁+1:M₂,
    S = S + fₑ(i);
    S2 = S2 + |fₑ(i)|²;
  End
  Let A = S/M₂; A2 = sqrt ([S2−A*A*M₂] / [M₂−1]);
  $If ( A - \frac{2}{k + 1} A 2 ) \cdot ( A + \frac{2}{k + 1} A 2 ) > 0 ( See note 1 )$
    Set B as −A;
  Else
    Set B as 0;
  End
  Update S and S2
  S2 = S2 + 2*S* B + B*B*M₂;
  S = S + M₂*B;
  $When \frac{2}{k + 1} A 2 < Δ and k > 5 , j ump out from the loop .$
End
```

Note 1:
According to the theory of statistics, the real value of the CFO is in the range of
$[ A - \frac{2}{k + 1} A 2 , A + \frac{2}{k + 1} A 2 ] with probability of 90 \% . I f ( A - \frac{2}{k + 1} A 2 ) \cdot \\ ( A + \frac{2}{k + 1} A 2 ) > 0 ,$ the polarity of the CFO is correct with a probability of 90%.

In step two, according to the theory of statistics, the variance of the real value of the CFO is in the range of [0.7A2, 1.5A2] with probability of 95% when M₂>15. When M₂>15, the variance of CFO detection is acquired with much higher accuracy. Conservatively, suppose the variance has the value of σₑ=3A2. Since, the target residual CFO is set as Δ (e.g., 0.02), thus the bandwidth of the frequency-locked loop is not larger than

$${B}_{L 0} = \frac{{Δ}^{2}}{2 {σ}_{e}^{2}} .$$

In step two, set B=0; choose a value of B_{L1} that is less than B_{L0}. Then the controller 40 calculates the values of Kᵢ and Kₚ through the following formulas:

$$ξ = \frac{1}{\sqrt{2}} , {T}_{s} = 1 , {ω}_{n} = \frac{8 {B}_{L} ξ}{1 + 4 {ξ}^{2}} \\ \{ \begin{matrix}{ω}_{n}^{2} = \frac{{K}_{i}}{{T}_{s}^{2}} ⇒ {ω}_{n} = \frac{\sqrt{{K}_{i}}}{{T}_{s}} ⇒ {K}_{i} = {ω}_{n}^{2} \cdot {T}_{s}^{2} \\ 2 {ξω}_{n} ⇒ ξ = \frac{{K}_{p}}{2 \sqrt{{K}_{i}}} ⇒ {K}_{p} = 2 {ξω}_{n} {T}_{s}\end{matrix} \qquad ( 6 )$$

That is, in step two, the controller works once and Kᵢ, Kₚ, and B (i.e., B=0) will be decided firstly with the parameters B_{L1}. They will be fixed in the coming L cycles (e.g., L=100). In each one of the L cycles, CFO detector 11 detects the CFO and feed it into the computational circuit (not shown) of the receiver to generate the equivalent carrier frequency fₒ used to demodulate the transmitter's signal.

After L cycles, the controller 40 works once again and updates Kᵢ, Kₚ with new parameters (e.g., BL₂<B_{L1}). In each one of the L cycles, CFO detector 11 detects the CFO and feed it into the computational circuit (not shown) of the receiver to generate the equivalent carrier frequency fₒ used to demodulate the transmitter's signal.

To evaluate the performance of the CFO synchronizer 200 of FIG. 2, numeric simulation is performed. Suppose that the initial CFO is Φ=0.2 , and the standard deviation of the detected CFO is 0.1. Conventional lock loops similar to FIG. 1 are chosen as references with noise bandwidth of 0.1, 0.01, and 0.001 respectively. If the lock loop converges, fₒ will approach 0. A metric G is defined to measure the overall residual offset during the converging procedure as shown in formula (7).

$$G ( L ) = {\sum }_{i = 1}^{L} \vert {f}_{0} ( i ) \vert \qquad ( 7 )$$

If the value of metric G is too large, it indicates that the receiver suffers from a large residual CFO for a long period of time. By way of example, L is chosen as 200 in the simulation. Another metric E is defined to measure the overall residual offset after the converging procedure as shown in formula (8).

$$E = \sqrt{\frac{1}{{L}_{2} - L} {\sum }_{i = L + 1}^{{L}_{2}} {\vert {f}_{0} ( i ) \vert}^{2}} \qquad ( 8 )$$

A small value of metric E indicates that the quality of carrier frequency-locked loop is high. By way of example, L2 is chosen as 10000 in the simulation.

FIG. 4 is a chart illustrating the probability distribution function (PDF) values of the G metric of a conventional CFO synchronizer with various noise bandwidth values and the value of the G metric of a CFO synchronizer according to the exemplary embodiment.
FIG. 5 is a chart illustrating the PDF values of the E metric of a conventional CFO synchronizer with various noise bandwidth values and the value of the E metric of a CFO according to the exemplary embodiment.

Referring to FIG. 4, when a large noise bandwidth (e.g., B_{L}=0.1) is selected for a conventional CFO synchronizer, the residual CFO is small in the converging procedure. However, the CFO synchronizer according to the exemplary embodiment still shows the smallest residual CFO in the converging procedure.

Referring to FIG. 5, when a large noise bandwidth (e.g., B_{L}=0.1) is chosen for a conventional CFO, the residual CFO is very large after the converging procedure. On the contrary, the CFO synchronizer according to the embodiment shows the smallest residual CFO after the converging procedure and performs the best.

FIG. 6 illustrates a flowchart of a method of synchronizing a receiver to the frequency of a transmitter according to one embodiment of the present invention.

Referring to FIG. 6, in step S1, a transmitted signal from a transmitter is received by a receiver. In step S2, a CFO between the transmitted signal and a local reference signal is estimated or determined by using a suitable CFO detector known in the art. In step S3, the values of parameters of a suitable frequency-locked loop are determined by the procedures set forth in reference to FIGS. 2-3. In step S4, the values of parameters of the frequency-locked loop is updated with the values determined in step S3. As a result, the frequency of the local reference signal is adjusted. In step S5, whether the frequency-locked loop has achieved frequency tracking of the carrier frequency is determined. If frequency tracking is not achieved yet, the steps of S3-S5 can be repeated until frequency tracking is achieved.

Accordingly, the embodiments of the present provide a CFO synchronizer and method that can achieve faster frequency tracking than conventional synchronizers.

Although certain exemplary embodiments of the present invention have been disclosed for illustrative purposes, those skilled in the art will appreciate that various modifications, additions and substitutions are possible, without departing from the scope and spirit of the present invention as disclosed in the accompanying claims and their equivalents.

What is claimed is:

1. A method of synchronizing a receiver to a received orthogonal frequency division multiplexing (OFDM) signal, the receiver comprising a carrier frequency offset synchronizer having a carrier frequency offset detector and a frequency-locked loop, the method comprising:
a) receiving a transmitted signal having a carrier frequency;
b) estimating a carrier frequency offset by comparing the carrier frequency of the transmitted signal and a reference frequency of a locally generated signal of the receiver;
c) determining a plurality of parameters of the frequency-locked loop to adjust the reference frequency to reduce the carrier frequency offset, the plurality of parameters being determined in accordance with the carrier frequency offset estimated in step b);
d) adjusting the frequency-locked loop to adjust the reference frequency according to the plurality of parameters determined in step c); and
e) repeating steps b), c) and d) for a successive number of OFDM sample times until frequency tracking of the OFDM signal is achieved.

2. The method of claim 1, wherein step c) comprises:
a) computing a number M₁ and a number M₂ as
M₁=k*k; (when k=1, M₁=0),
M₂=(k+1)*(k+1),
wherein k has an initial value of 1;
b) computing a number S and a number S2 as
S=S+fₑ(i), (initially S=0; S2=0)
S2=S2+|fₑ(i)|²,
wherein fₑ(i) is the estimated carrier frequency offset, and i has an initial value of M₁+1, then step b) is repeated and i is incremented by one every time step b) is repeated until i=M₂;
c) computing a number A and a number A2 as
A=S/M2; A2=sqrt ([S2-A*A*M2]/[M2-1]),
d) determining a number B as
$$if ( A - \frac{2}{k + 1} A 2 ) \cdot ( A + \frac{2}{k + 1} A 2 ) > 0 , \\ set B as - A , \\ else$$
$$set B as 0 ;$$
e) changing the numbers S and S2 as
S=S+M₂*B,
S2=S2+2*S*B+B*B*M₂; and
f) updating the value of k as k=k+1.

3. The method of claim 2, wherein the steps a)-f) of claim 2 is repeated when both of the following two conditions are met:
k is less than or equal to 30; and
$$\frac{2}{k + 1} A 2 \geq Δ and k \leq 5 ,$$
wherein Δ is the desired offset value.

4. The method of claim 3, wherein step c) of claim 1 further comprises:
a) determining a variance σₑ of the carrier frequency offset;
b) determining a noise bandwidth B_{L} of the frequency-locked loop as
$${B}_{L} = \frac{{Δ}^{2}}{2 {σ}_{e}^{2}} ,$$
wherein Δ is the desired carrier frequency offset;
c) setting the value of B as B=0;
d) determining the values of the plurality of parameters of the frequency-locked loop as
$$ξ = \frac{1}{\sqrt{2}} , {T}_{s} = 1 , {ω}_{n} = \frac{8 {B}_{L} ξ}{1 + 4 {ξ}^{2}}$$
$$\{ \begin{matrix}{ω}_{n}^{2} = \frac{{K}_{i}}{{T}_{s}^{2}} = > {ω}_{n} = \frac{\sqrt{{K}_{i}}}{{T}_{s}} = > {K}_{i} = {ω}_{n}^{2} \cdot {T}_{s}^{2} \\ 2 {ξω}_{n} = > ξ = \frac{{K}_{p}}{2 \sqrt{{K}_{i}}} = > {K}_{p} = 2 {ξω}_{n} {T}_{s}\end{matrix} ,$$
wherein the behavior of the frequency-locked loop is adjusted according to the plurality of parameters.

5. The method of claim 4, wherein the frequency-locked loop adjusted according to the plurality of parameter is operated for a number of cycles, then the value of B_{L} is changed to determine a new set of values of the plurality of parameters of the frequency-locked loop according to the step d) of claim 4.

6. The method of claim 5, wherein the number of cycles is between 50-200.

7. The method of claim 5, wherein the value of B_{L} is changed to a smaller value.

8. The method of claim 5, wherein the value of B_{L} is reduced multiple times to determine a successive sets of values of the plurality of parameters to further reduce the carrier frequency offset.

9. An apparatus for synchronizing a receiver to an orthogonal frequency division multiplexing (OFDM) signal, comprising:
a carrier frequency offset detector for receiving the OFDM signal and outputting an offset signal;
a loop filter coupled to the carrier frequency offset detector for receiving the offset signal and outputting a filtered signal;
a compensating unit coupled to the loop filter for receiving the filtered signal and outputting a compensation signal; and
a controller coupled to the carrier frequency offset detector to receive the offset signal and the compensating unit to receive the compensation signal, the controller configured to control a plurality of performance parameters of the loop filter,
wherein the carrier frequency offset detector is configured to compare the received OFDM signal with a local reference signal adjusted by the compensation signal to produce the offset signal.

10. The apparatus of claim 9, wherein the compensating unit comprises a numeric oscillator.

11. The apparatus of claim 10, wherein the numeric oscillator comprises a coordinate rotation digital computer (CORDIC).

12. The apparatus of claim 9, wherein the controller is coupled to the loop filter to control the loop filter in accordance with the plurality of performance parameters of the loop filter.

13. The apparatus of claim 9, wherein the controller is further configured to output a control signal to modify the filtered signal and provide the modified filtered signal to the compensation unit.
